(19) United States
(12) Patent Application Publication
(10) Pub. No.: US 2023/0354847 A1
(43) Pub. Date: Nov. 9, 2023

(54) ICE CREAM CATCHER AND DISPENSER FOR FROZEN CONFECTION TOPPINGS

(71) Applicant: Scott King, Durham, CT (US)

(72) Inventor: Scott King, Durham, CT (US)

(21) Appl. No.: 18/221,663

(22) Filed: Jul. 13, 2023

Related U.S. Application Data
(63) Continuation of application No. 16/654,253, filed on Oct. 16, 2019.
(60) Provisional application No. 62/749,824, filed on Oct. 24, 2018.

(51) Int. Cl. A23G 9/50; A23G 9/22; A23G 9/28; B65D 85/78

(52) U.S. Cl. CPC A23G 9/506; A23G 9/221; A23G 9/288; B65D 85/78

(57) ABSTRACT

A device for reducing dripping or spillage of a frozen confection food item during the consumption of the food item that includes a catcher device which catches melting ice cream or frozen confection. There is also provided a food additive arrangement that can be used with a food dispenser to enable a food additive to be easily and conveniently mixed with the food item as the food item is being dispensed from the dispenser.

The present disclosure is a continuation of U.S. patent application Ser. No. 16/654,253 filed Oct. 16, 2019, which in turn claims priority on U.S. Patent Application Ser. No. 62/749,824 filed Oct. 24, 2018, which are incorporated herein by reference.

The present disclosure relates to food items, to the method for using the food item and to the method for manufacturing the food item.

### BACKGROUND

A cake cone, sugar cone, or waffle cone is a common item from which to eat ice cream or other type of frozen confections (e.g., soft serve ice cream, frozen custard, soft service frozen custard, frozen yogurt, soft serve frozen yogurt, ice slushes, gelato, sherbet, sorbet, water ices, frozen juices, frozen fudge confection, etc.). Generally, when served in the cone, ice cream or frozen confection is consumed right away and the cone is held in the hand of the consumer during the consumption of the ice cream. However, during the consumption of the ice cream or frozen confection, especially in a warm environment, it can become uncomfortable, messy, and/or unsanitary for consumers to enjoy the consumption of the ice cream or frozen confection from a cone due to the melting and dripping of the ice cream or frozen confection onto the outside of the cone and/or hand of the consumer holding the cone.

Flavoring of ice cream or frozen confection has become popular. Soft serve ice cream or yogurt is commonly topped with candy and/or chocolate syrup or other flavored syrups. Also, soft serve ice cream, yogurt, custard, or other types of frozen confections are commonly mixed in a blender or mixer with candy, and/or chocolate syrup or other flavored syrups and served in a cup (e.g., concrete dessert, etc.). However, when the ice cream or frozen confection is dispensed into a cone, the ice cream or frozen confection can only be topped with a topping, since the topping cannot be mixed into the ice cream or frozen confection after it has been dispensed onto a cone. Also, it can be difficult and time consuming to collect, dispense, and mix the desired toppings into the ice cream or frozen confection. This is especially so for persons in the food service industry who often must dispense the toppings and ice cream or frozen confection simultaneously. Alternatively, the ice cream or frozen confection is dispensed first and the toppings second, followed by a separate mixing process to ensure adequate dispersion of the toppings within the ice cream or frozen confection.

In view of the current state of the art, there is a need for a device which inhibits or prevents the dripping of ice cream or frozen confection onto the outside of the cone and/or hand of a consumer during the consumption of the ice cream or frozen confection. Also, there is a need for a dispenser arrangement which streamlines the dispensing and mixing of toppings into frozen confection food items.

### BRIEF DESCRIPTION OF THE DISCLOSURE

In one non-limiting aspect of the invention, there is provided a device for improving the consumption of a food product, and in particular to a device for reducing dripping or spillage of a food item during consumption of the food item, and still more particularly to a device for reducing dripping or spillage of a frozen confection food item during the consumption of the food item. Thus, one non-limiting object of the present disclosure is to provide a device which inhibits or prevents the dripping of ice cream or frozen confection onto the outside of the cone and/or hand of a consumer during the consumption of the ice cream or frozen confection. This non-limiting aspect of the invention finds particular application in conjunction with a catcher device which catches melting frozen confections such as, but not limited to, ice cream, soft serve ice cream, frozen yogurt, soft serve yogurt, frozen custard, soft serve custard, snow cone, ice slushes, gelato, sherbet, sorbet, water ices, frozen juices, frozen fudge confection, ice slushes, gelato, sherbet, sorbet, water ices, frozen juices, frozen fudge confection, or other type of frozen or soft serve confection, and will be described with particular reference thereto.

In another and/or alternative non-limiting aspect of the invention, there is provided a food additive arrangement that can be used with a food dispenser to enable a food additive to be easily and conveniently mixed with the food item as the food item is being dispensed from the dispenser, and particularly to a food additive arrangement that can be used with a food dispenser to enable a food additive (e.g., nuts, candy, syrup, liquid chocolate, liquid caramel, whipped cream, marshmallow filling, etc.) to be easily and conveniently mixed with the food item (e.g., ice cream, soft serve ice cream, frozen yogurt, soft serve yogurt, frozen custard, soft serve custard, gelato, sherbet, sorbet, frozen fudge confection, or other type of frozen or soft serve confection, etc.) as the food item is being dispensed from the dispenser. This non-limiting aspect streamlines the dispensing and mixing of toppings into frozen confection food items. As such, the food additive arrangement can be used to dispense and mix additives (e.g., fruit, vegetables, meat [e.g., bacon bits, etc.], nuts, cookies, fudge, brownies, cookie dough, cake dough, cake, pie fillings, cake fillings, crème fillings, pudding, custard, gum, candy [chocolate and other non-chocolate candy], and confection, and/or flavorings [e.g., liquid or soft chocolate, chocolate syrup, cream, whipped cream, liquid or soft caramel, caramel syrup, liquid or soft butterscotch, butterscotch syrup, fruit syrup, fruit jelly or preserves, crushed fruit, liquors, liquid flavorings, whipped marshmallow topping or filling, etc.]) into the ice cream or frozen confection as the ice cream or frozen confection continuously flows from the dispenser and into the cone or a container. The food additive arrangement can also be used to control the amount of food additive that is added into the ice cream or frozen confection as the ice cream or frozen confection continuously flows from the dispenser and into the cone or container.

In accordance with another and/or alternative non-limiting aspect of the present disclosure, a device for maintaining cleanliness during consumption of frozen confection food items is disclosed. The device can be a non-edible device, an edible device, or a partially edible device. In one non-limiting embodiment, the device includes at least one catcher.

In accordance with still another aspect of the present disclosure, there is provided a dispensing/mixing apparatus for simultaneously dispensing a frozen confection food item and at least one topping.

In accordance with still another aspect of the present disclosure, there is provided a device for limiting melted frozen confection from running down an outside of an ice cream cone comprising a confectionary catcher. The confectionary catcher includes an upper and lower body portion. The upper body portion has a rim, a catch basin, and a central opening. A bottom surface of the rim is size and configured such that the rim fully encircles an upper lip of the ice cream cone when the confectionary catcher is used with the ice cream cone. The size, shape, and configuration of the rim is non-limiting. At least a portion of the rim extends upwardly above the upper lip of the ice cream cone when the confectionary catcher is used with the ice cream cone. A top edge of the upper lip of the rim has an outer perimeter that is greater than an outer perimeter of the upper lip of the ice cream cone. The lower body portion includes a cavity that is configured to at least partially receive a base portion of the ice cream cone when the confectionary catcher is used with the ice cream cone. The upper and lower body portions are connected together. In one arrangement, the upper and body portion are formed from a single piece of material. (e.g., confectionary, plastic, paper board, cardboard, paper, etc.). The cavity of the lower portion generally has a profile that is the same or similar to an outer profile as the ice cream cone. A maximum cross section area of the upper body portion is greater than a maximum cross section area of the lower body portion. The longitudinal length of the upper body portion is generally less than a longitudinal length of the lower body portion. At least a portion of the catch basin is optionally sized and configured to fully encircle an upper lip of the ice cream cone when the confectionary catcher is used with the ice cream cone. The rim of the upper body portion optionally angles outwardly and upwardly from the lower body portion. The catch basin optionally extends outwardly from the central opening of the upper body portion and the rim extends upwardly from the catch basin. A lower portion of the rim optionally extends downwardly from the catch basin and partially encircles a portion of the lower body portion that is located below the catch basin. In such an arrangement, the lower portion of the rim extends downwardly a length that is no more than 50% of the longitudinal length of the lower body portion, and typically no more than 30% of the longitudinal length of the lower body portion. The bottom of the lower body portion of the device is optionally closed such that the cavity fully covers all the outer surfaces of the base portion of the ice cream cone that is located in the cavity. The cavity optionally forms a liquid trap to retain liquid that enters the cavity when the confectionary catcher is used with the ice cream cone. The bottom of the lower body portion is optionally open such that at least a portion of the base portion of the ice cream cone extends below the lower body portion when the confectionary catcher used with the ice cream cone.

In accordance with still another aspect of the present disclosure, there is provided a device for limiting melted frozen confection from running down an outside of an ice cream cone comprising an edible confectionary catcher. The edible confectionary catcher includes an upper and lower body portion. The upper body portion has a rim, a catch basin, and a central opening. A bottom surface of said rim is size and configured such that at least a portion of the bottom surface rests on an upper lip of the ice cream cone when the edible confectionary catcher is used with the ice cream cone. At least a portion of the rim extends upwardly above the upper lip of the ice cream cone when the edible confectionary catcher used with the ice cream cone. A top edge of the upper lip of the rim has an outer perimeter that is greater than an outer perimeter of the upper lip of the ice cream cone. The lower body portion is configured to be at least partially inserted into the cavity of the ice cream cone when the edible confectionary catcher is used with the ice cream cone. The lower body portion includes a cavity having a top opening that opens to the central opening of the upper body portion and a bottom opening that openings into an interior of the ice cream cone when the edible confectionary catcher is used with the ice cream cone. The upper and lower body portions are connected together. A maximum cross section area of the upper body portion is greater than a maximum cross section area of the lower body portion. The lower body portion optionally includes a plurality of securing tabs that are spaced from one another. The number of securing tabs, the width of the securing tabs and the spacing of the securing tabs are non-limiting. In one non-limiting arrangement, the size and shape of a plurality of securing tabs or all of the securing tabs is the same. The longitudinal length of one or more of the securing tabs is at least 25% of the longitudinal length of the lower body portion, typically at least 50% of the longitudinal length of the lower body portion, and more typically at least 55% of the longitudinal length of the lower body portion. Generally, a longitudinal length of a gap located between two of said security tabs is less than a longitudinal length of said lower body portion. The catch basin optionally extends outwardly from the central opening and the rim optionally extends upwardly from an outer peripheral edge of said catch basin. In one non-limiting arrangement, the catch basin optionally has a generally planar flat top surface that lies in a plane that is generally perpendicular to the longitudinal axis of the lower body portion. In another non-limiting embodiment, the width of the catch basin is optionally the same as or less than a width of the rim. The rim optionally includes a plurality of catch regions having a curvilinear profile. In one non-limiting arrangement, a plurality of adjacently positioned catch regions form a sinusoidal profile about at least a portion of the upper edge of the rim. The upper body portion optionally includes a plate portion positioned on a portion of the rim. In one non-limiting arrangement, the plate portion is positioned between two catch regions. The plate portion can include a flat portion and a raised peripheral edge. The flat portion can be used to include information (e.g., branding, trademarks, company names, etc.). At least a portion of a bottom surface of the catch basin optionally rests on an upper lip of the ice cream cone when the edible confectionary catcher used with the ice cream cone. The rim of the upper body portion optionally angles outwardly and upwardly from the lower body portion. The edible confectionary catcher can be optionally used on a preexisting ice cream cone or be configured as a substitute for the upper portion of an ice cream cone. The edible confectionary catch can be optionally formed of chocolate, hard candy, fruit, soft candy (e.g., gummies), cookies, wafers, crackers, etc., and the like.

In accordance with still another aspect of the present disclosure, there is provided an apparatus for simultaneously dispensing/mixing a wide variety of toppings with a frozen confection. The apparatus comprises a hopper configured to store one or more of said toppings. The one or more toppings can be solid, liquid, and/or semisolid. The apparatus also includes a conveying tube connected to the hopper at a first end of said conveying tube. The apparatus also includes a conveying arrangement that is at least partially positioned in the conveying tube. The conveying arrangement is configured to enable the one or more toppings to move from the hopper, through the conveying tube, and out an end opening in a second end of the conveying tube. The conveying arrangement includes a transporter and a motor. The transporter can be in the form of an auger, a conveying belt, a piston, a plunger, etc. The motor is configured to cause the transporter to move to thereby enable the one or more toppings to move from the hopper through the conveying tube, and to the end opening in the second end of the conveying tube. The second end of the conveying tube is positioned below a dispensing opening in the frozen confection dispenser and above a location where the frozen confection from the frozen confection dispenser is deposited in an ice cream cone or a container. The hopper includes an opening to enable the one or more toppings to move into the conveying tube. The conveying tube optionally angles downwardly from a base of the hopper. The downward angle is generally no more than 90°, and is typically about 1-80° (and all values and ranges therebetween), and more typically about 5-40°. The conveying arrangement is optionally automatically activated when frozen confection is dispensed from the frozen confection dispenser. The conveying arrangement is optionally automatically deactivated when frozen confection is not dispensed from the frozen confection dispenser. The conveying arrangement optionally includes a sensing arrangement to sense whether frozen confection is dispensed from the frozen confection dispenser. The apparatus optionally further includes a mount attachment connected to the hopper. The mount attachment, when used, is optionally configured to connect the apparatus to the frozen confection dispenser. The apparatus optionally further includes an attachment tube. The attachment tube includes a top opening, a bottom opening, and a side opening. The side opening is optionally connected to the end opening in the second end of the conveying tube. The top opening is configured to receive frozen confection that has been dispensed from the frozen confection dispenser when the attachment tube is connected to the frozen confection dispenser. The bottom opening is configured to allow the frozen confection that enters the top opening to exit the attachment tube by gravity via the bottom opening. A longitudinal axis of the attachment tube is optionally configured to be parallel with an axis of dispensement of the frozen confection from the frozen confection dispenser; however, this is not required. A portion of said conveying arrangement optionally extends into said attachment tube. The conveying arrangement optionally includes a piston or plunger, wherein the piston or plunger is configured to move along at least a portion of the conveying tube between an extended and retracted position. The apparatus optionally further includes an attachment tube, wherein the attachment tube includes a top opening, a bottom opening, and a side opening. The side opening is optionally connected to the end opening in the second end of the conveying tube. The top opening is configured to receive frozen confection that has been dispensed from the frozen confection dispenser when the attachment tube is connected to the frozen confection dispenser. The bottom opening is configured to allow the frozen confection that enters the top opening to exit the attachment tube by gravity via the bottom opening. A longitudinal axis of the attachment tube is optionally configured to be parallel with an axis of dispensement of the frozen confection from the frozen confection dispenser. The end of the piston or plunger is optionally configured to move along at least a portion of the conveying tube between an extended and retracted position. The piston or plunger in the extended position is located only partially or is not located in the attachment tube, thereby allowing the one or more toppings to enter the attachment tube.

In accordance with still another aspect of the present disclosure, there is provided an apparatus for simultaneously dispensing/mixing a wide variety of toppings with a frozen confection wherein the apparatus optionally includes a limit switch for signaling a motor to start or stop the conveying arrangement. The limit switch can optionally be included in the attachment bracket, which bracket (when used) is adapted to attach the apparatus to the dispensing machine. The limit switch can be used to operatively engage a component of the dispensing mechanism when frozen confection is not being dispensed from machine so as to prevent the conveying arrangement from activating.

In accordance with still another aspect of the present disclosure, there is provided an apparatus for simultaneously dispensing/mixing a wide variety of toppings with a frozen confection wherein the conveying arrangement of the apparatus is activated when the lever on the frozen confection dispenser is raised to cause the frozen convection to be dispensed from the frozen confection dispenser so that the one or more toppings simultaneously dispensed with the frozen confection.

These and other objects, features and advantages of the present invention will become apparent in light of the following detailed description of the non-limiting preferred embodiments thereof, as illustrated in the accompanying drawings.

### BRIEF DESCRIPTION OF THE DRAWINGS

FIG. 1A is an illustration according to one non-limiting embodiment of the present disclosure showing a perspective side view of various devices referred to as ‘catchers’, configured to catch drips of melted frozen confection, and adapted to fit around the exterior surface of or within the interior of large to small ice cream cones.

FIG. 1B is an illustration showing a perspective bottom view of the catchers of FIG. 1A wherein the flat bottoms of each of the catchers can be seen.

FIG. 1C is an illustration showing a perspective side view of the catchers of FIGS. 1A and 1B in a mated configuration with associated large to small ice cream cones.

FIG. 2A is an illustration according to a second non-limiting embodiment of the present disclosure that shows a perspective top view of various devices referred to as ‘edible catchers’, configured to catch drips of melted frozen confection, and adapted to fit within the upper portion of the interior of large to small ice cream cones.

FIG. 2B is an illustration showing a perspective bottom view of the edible catchers of FIG. 2A wherein finger or tab structures for mating with associated ice cream cones can be seen.

FIG. 2C is an illustration showing a perspective top view of the edible catchers of FIGS. 2A and 2B in a mated configuration with associated large to small ice cream cones.

FIG. 2D is an illustration showing a perspective top view of a large sized edible catcher from FIGS. 2A-2C which includes a plate for displaying a company mark or logo.

FIG. 3A is an illustration according to a third non-limiting embodiment of the present disclosure that shows a side view of an apparatus for dispensing and mixing toppings simultaneously with a frozen confection food item such as ice cream.

FIG. 3B is an illustration showing a perspective side view of a system in a “pre-dispensing” configuration including the apparatus of FIG. 3A attached to a machine for dispensing the frozen confection food item.

FIG. 3C is an illustration showing a perspective side view of the system of FIG. 3B in a “dispensing” configuration.

FIG. 4A is an illustration according to a fourth non-limiting embodiment of the present disclosure that shows a side view of another apparatus for dispensing and mixing toppings simultaneously with a frozen confection food item such as ice cream.

FIG. 4B is an illustration showing a perspective side view of a system in a “pre-dispensing” configuration including the apparatus of FIG. 4A attached to a machine for dispensing the frozen confection food item.

FIG. 4C is an illustration showing a perspective side view of the system of FIG. 4B in a “dispensing” configuration.

FIG. 5A is an illustration according to a fifth non-limiting embodiment of the present disclosure that shows a side view of a different apparatus for dispensing and mixing toppings simultaneously with a frozen confection food item such as ice cream.

FIG. 5B is an illustration showing a perspective side view of a system in a “pre-dispensing” configuration including the apparatus of FIG. 5A attached to a machine for dispensing the frozen confection food item.

FIG. 5C is an illustration showing a perspective side view of the system of FIG. 5B in a “dispensing” configuration.

FIG. 6A is an illustration according to a sixth non-limiting embodiment of the present disclosure that shows a perspective side view of an apparatus for dispensing and mixing liquid toppings simultaneously with a frozen confection food item such as ice cream.

FIG. 6B is an illustration showing a perspective side view of a system in a “pre-dispensing” configuration including the apparatus of FIG. 6A attached to a machine for dispensing the frozen confection food item.

FIG. 6C is an illustration showing a perspective side view of the system of FIG. 6B in a “dispensing” configuration.

FIG. 6D is an illustration showing a perspective side view of the system of FIG. 6B in a “fully dispensed” configuration.

FIGS. 7A-7B illustrate a non-limiting molding arrangement that can be used to form the catchers illustrated in FIGS. 2A-2D.

### DETAILED DESCRIPTION

A more complete understanding of the articles/devices, processes, and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

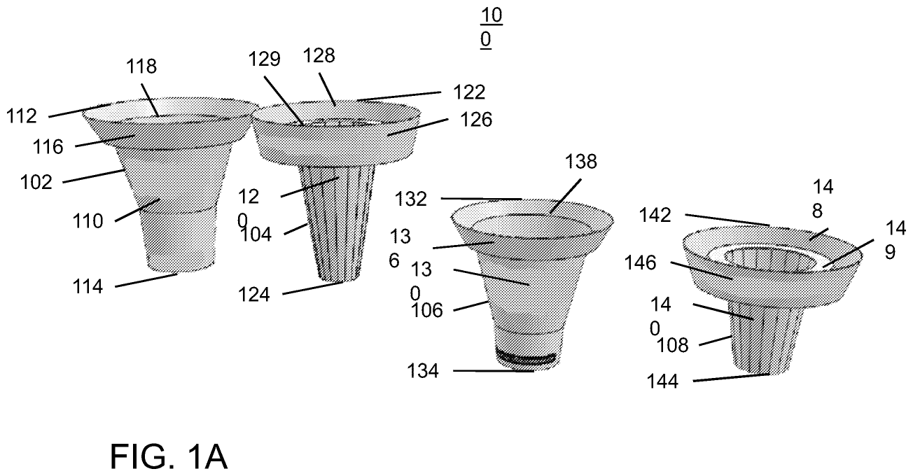

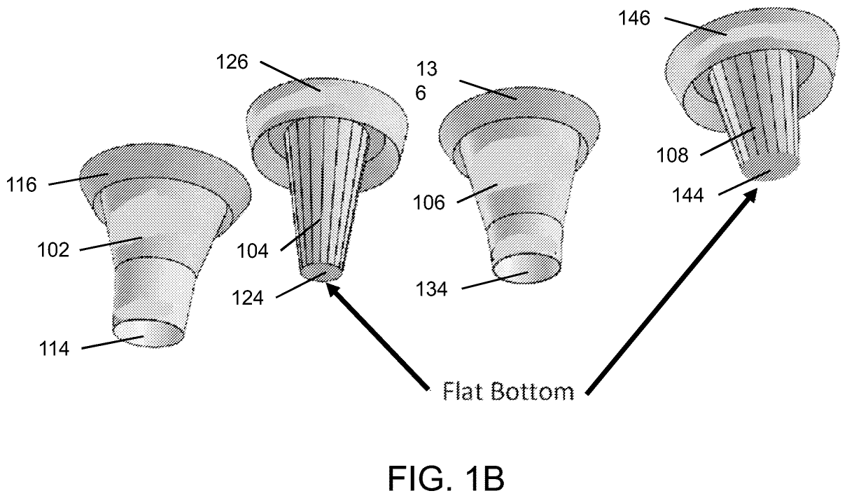

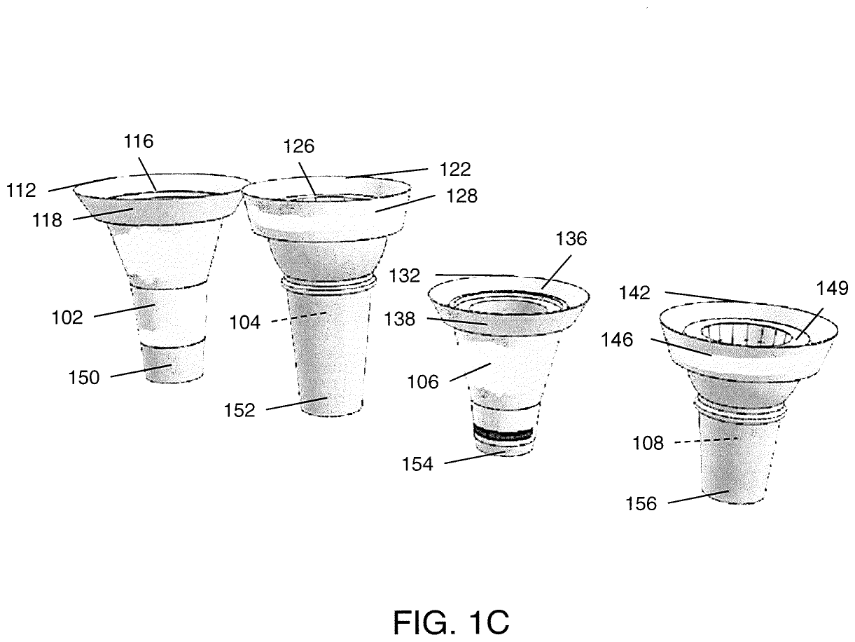

Referring now to the drawings wherein the showing is for the purpose of illustrating preferred embodiments of the invention only and not for the purpose of limiting the same, FIGS. 1A-1C illustrate a first exemplary non-limiting embodiment of the present disclosure is illustrated. In particular, FIGS. 1A-1C illustrate multiple confectionary catchers 100 for use with ice cream cones of various sizes. The confectionary catchers all generally include a body portion, an upper portion having a circular rim and a catch basin, and a lower portion. Four different non-limiting confectionary catchers 102, 104, 106, and 108 are shown which are adapted to fit either around or within large or small ice cream cones.

Catcher 102 is adapted to fit around an outer surface of a large-sized corresponding cone, such as cone 150 shown in FIG. 1C. A body 110 of the catcher 102 generally comprises a frusto-conical shape (or some other shape) having an upper body portion 112 and a lower body portion 114. The upper body portion 112 is open to accommodate insertion of the cone 150 into the catcher 102. The lower body portion 114 can be open such that the bottom of a corresponding ice cream cone is exposed. Alternatively, the lower body portion 114 can be closed such that the bottom of a corresponding ice cream cone is supported on the lower portion of the catcher 102. The upper body portion 112 of the catcher 102 includes a drip-catching basin 116 that extends circumferentially and radially outward from the body 110. In contrast, the lower body portion 114 generally includes a flat bottom; however, this is not required.

While the drip-catching basin 116 shown in FIGS. 1A-1C is illustrated as having a generally uniform and continuous shape around the circumference thereof, the basin can have any desired shape without departing from the scope of the present disclosure. However, the drip-catching basin 116 should generally be shaped and sized to provide a sufficient capacity to catch and retain as much drip as may be required. In this regard, the drip-catching basin 116 includes a turned-up flange or rim 118 to aid in catching and retaining the drip within the catch basin.

Next, catcher 104 illustrated in FIGS. 1A-1C is adapted to at least partially fit within an inner surface of a large-sized corresponding cone, such as cone 152 shown in FIG. 1C. A body 120 of the catcher 104, similar to body 110 of catcher 102, generally comprises a frusto-conical shape (or some other shape) having an upper body portion 122 and a lower body portion 124. The body 120 of catcher 104, however, is comparatively narrower between upper and lower body portions 122, 124 than body 110 of catcher 102 to enable a snug fit within corresponding ice cream cone 152. The upper body portion 122 is open to receiving a scoop or scoops of ice cream (not shown) therein. The lower body portion 124 can be open such that melted drip collects in the bottom of a corresponding ice cream cone. Alternatively, the lower body portion 124 can be closed such that melted drip collects in the lower portion of the catcher 104 instead of the associated ice cream cone. The upper body portion 122 of the catcher 104 includes a drip-catching basin 126 that extends circumferentially and radially outward from the body 120. In contrast, the lower body portion 124 generally includes a flat bottom; however, this is not required.

While the drip-catching basin 126 shown in FIGS. 1A-1C is illustrated as having a generally uniform and continuous shape around the circumference thereof, the basin can have any desired shape without departing from the scope of the present disclosure. However, similar to the drip-catching basin 116 of catcher 102, drip-catching basin 126 should generally be shaped and sized to provide a sufficient capacity to catch and retain as much drip as might be required. In this regard, the drip-catching basin 126 includes a turned-up flange or rim 128 to aid in catching and retaining the drip within the catch basin. In contrast to rim 118 of drip-catching basin 116, rim 128 of catch basin 126 includes a ledge portion 129 adapted to rest on top of associated ice cream cone 152, thereby providing support for catcher 104.

The next exemplary catcher illustrated in FIGS. 1A-1C is catcher 106, which is adapted to fit around an outer surface of a small-sized corresponding cone, such as cone 154 shown in FIG. 1C. In this regard, catcher 106 generally includes all the same components as catcher 102, only smaller. That is, catcher 106 includes a body 130 comprising a frusto-conical shape (or some other shape) having an open upper body portion 132 and a flat lower body portion 134 which can be open or closed. The upper body portion 132 of the catcher 106 includes a drip-catching basin 136 that extends circumferentially and radially outward from the body 130. The catch basin 136 includes a turned-up flange or rim 138 to aid in catching and retaining the drip within the catch basin.

The last exemplary catcher illustrated in FIGS. 1A-1C is catcher 108, which is adapted to fit within an inner surface of a small-sized corresponding cone, such as cone 156 shown in FIG. 1C. In this regard, catcher 108 generally includes all the same components as catcher 104, only smaller. That is, catcher 108 includes a body 140 comprising a frusto-conical shape (or some other shape) having an open upper body portion 142 and a flat lower body portion 144 which can be open or closed. The body 140 of catcher 108 is comparatively narrower between upper and lower body portions 142, 144 than body 130 of catcher 106 and is comparatively shorter than body 120 of catcher 104. The upper body portion 142 of the catcher 108 includes a drip-catching basin 146 that extends circumferentially and radially outward from the body 140. The catch basin 146 includes a turned-up flange or rim 148 to aid in catching and retaining the drip within the catch basin. The rim 148 of drip-catching basin 146 includes a ledge portion 149 adapted to rest on top of associated ice cream cone 156, thereby providing support for catcher 108.

Catchers 102, 104, 106, and 108, including respective body portions 110, 120, 130, and 140 thereof, may be made of any desired material which provides a construction that will in some degree conform to the shape of associated ice cream cones 150, 152, 154, 156. Suitable materials may also be chosen for their ability to resist moisture from the melted drip collected in catchers 102, 104, 106, 108. Exemplary materials for the catchers 102, 104, 106, 108 include but are not limited to, paper, paper board, cardboard, coated paper or paper board or cardboard, plastic, etc., and the like. The thickness of the material is non-limiting. As can be appreciated, printed information (e.g., trademark markings, advertising, use information, etc.) can be optionally included on the catcher.

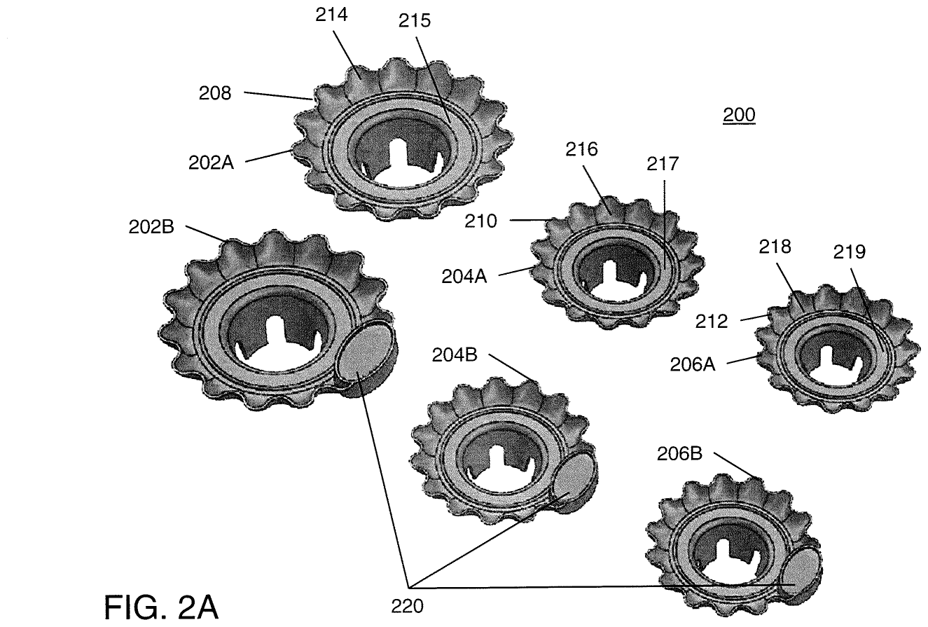

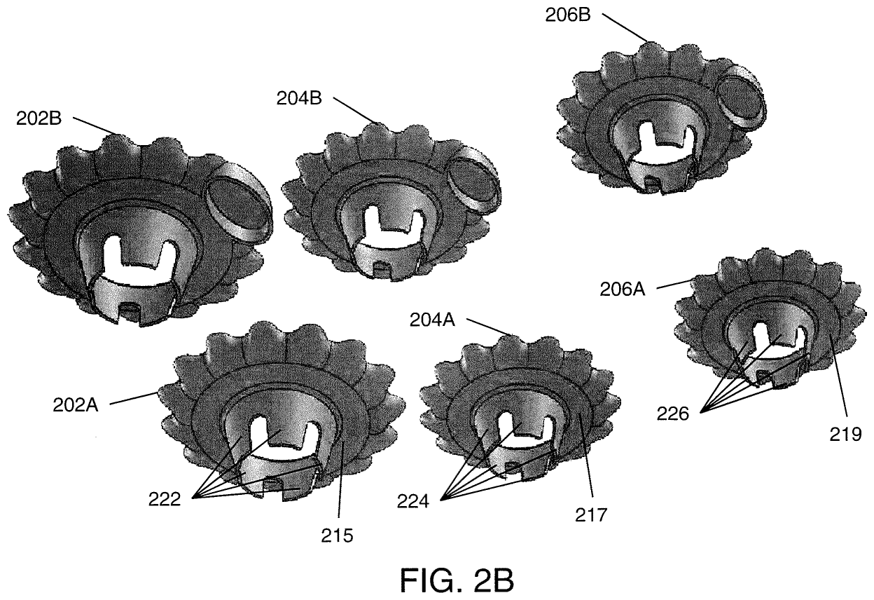

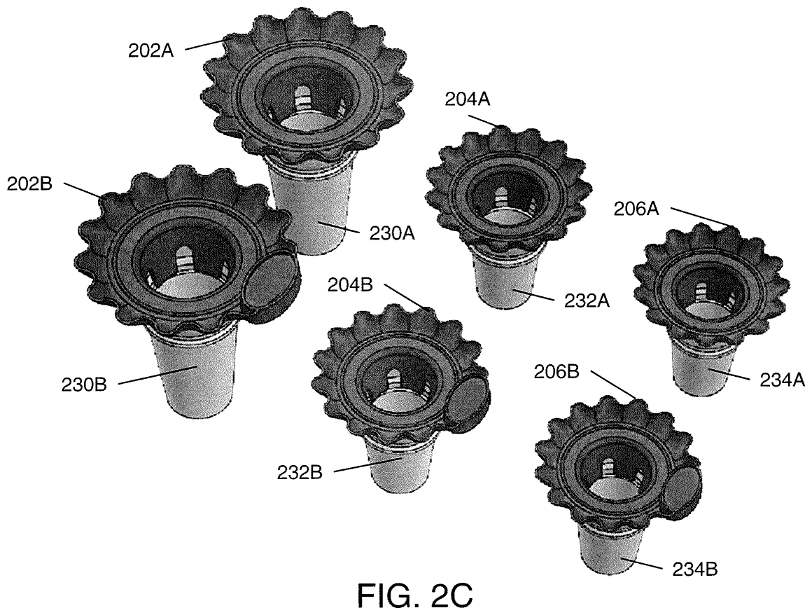

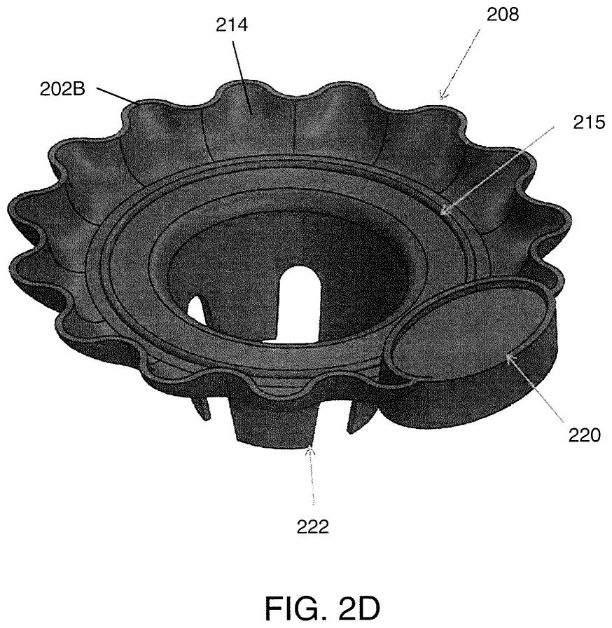

Referring now to FIGS. 2A-2D, a second exemplary non-limiting embodiment of the present disclosure is illustrated. In particular, FIGS. 2A-2C illustrate multiple edible confectionary catchers 200 for use with ice cream cones of various sizes. FIG. 2D illustrates a single edible confectionary catcher to better show the specific features thereof. The edible confectionary catchers all generally include a catch basin, a turned-up flange or rim, and a plurality of securing tabs. Six different non-limiting edible confectionary catchers 202A, 202B, 204A, 204B, 206A, 206B, 208A, and 208B are shown which are adapted to fit within large, medium, or small ice cream cones.

Edible catchers 202A, 204A, and 206A are adapted to fit within the upper portion of large-, medium-, and small-sized corresponding cones, respectively, such as cones 230A, 232A, and 234A shown in FIG. 2C. Edible catchers 202B, 204B, and 206B include substantially identical components as edible catchers 202A, 204A, and 206A and are also adapted to fit within the upper portion of large-, medium-, and small-sized corresponding cones, respectively, such as cones 230B, 232B, and 234B shown in FIG. 2C. In contrast to catchers 202A, 204A, and 206A, catchers 202B, 204B, and 206B all include a plate 220 which can be used to display the logo or mark of a particular manufacturer or restaurant. For convenience and easier understanding, the components of the multiple edible catchers illustrated in FIGS. 2A-2D will generally be discussed with respect to catchers 202A, 204A, and 206A, with the understanding that identical components are also included in catchers 202B, 204B, and 206B (with the exception of plates 220).

The upper body portion of the edible catchers 202A, 204A, and 206A each include a drip-catching basin 208, 210, and 212 having turned-up flange or rim portions 214, 216, and 218. Rim portions 214, 216, 218 flare upwardly and outwardly from corresponding ledge portions 215, 217, 219, respectively, and outwardly beyond the upper edges of cones 230B, 232B, and 234B. The ledge portions 215, 217, 219 are adapted to rest on top of the upper edges of their respective ice cream cones, thereby supporting the catchers from the undersides thereof. The transition between rim portions 214, 216, and 218 and ledge portions 215, 217, 219 is a substantially smooth-curve transition. As viewed from the top (FIGS. 2A and 2B), the drip-catching basins 208, 210, 212, rim portions 214, 216, 218, and ledge portions 215, 217, 219 are generally annular in shape and form a relatively shallow open-mouth circular receptacle for receiving a scoop or scoops of frozen confection therein; however, it can be appreciated that other shapes can be used.

While the drip-catching basins 208, 210, 212 shown in FIGS. 2A-2D are illustrated as having a generally decorative repeating curve shape around the circumference thereof, the drip-catching basin can have any desired shape without departing from the scope of the present disclosure. However, the drip-catching basins 208, 210, 212 should generally be shaped and sized to provide a sufficient capacity to catch and retain as much drip as may be required. In this regard, rim portions 214, 216, 218 aid in catching and retaining the drip within the drip-catching basin.

With specific reference to FIG. 2B, the lower body portion of each of the edible catchers 202A, 204A, 206A include a plurality of thin and radial fingers or tabs 222, 224, and 226, respectively. Tabs 222, 224, 226 extend downwardly and inwardly from corresponding ledge portions 215, 217, 219, respectively. In this regard, tabs 222, 224, 226 are disposed within associated cones 230A, 232A, 234A and optionally deflect against the curved interior sidewalls thereof, causing the same to resiliently grasp the cones; however, this is not required. As such, tabs 222, 224, 226 can be optionally adapted to help retain edible catchers 202A, 204A, 206A within the cones and resist accidental dislodgment of the edible catchers from the cones.

Edible drip-catching catchers 202A, 202B, 204A, 204B, 206A, 206B, 208A, and 208B may be made of any desired foodstuffs, ingredients, edible materials, etc., which provide a construction that will in some degree conform to the shape of associated ice cream cones 230A, 230B, 232A, 232B, 234A, and 234B. Exemplary materials for edible drip-catching catchers 202A, 202B, 204A, 204B, 206A, 206B, 208A, 208B include, but are not limited to chocolate, hard candy, fruit, soft candy (e.g., gummies), cookies, wafers, crackers, etc., and the like.

In another non-limiting embodiment, the edible drip-catching catchers of 202A, 202B, 204A, 204B, 206A, 206B, 208A, and 208B can be substituted for the top portion of an ice cream cone. In such arrangement, the tabs 222, 224, 226 of the edible drip-catching catchers are designed to engage the base of an ice cream cone that is absent the standard top portion of the ice cream cone such that when the edible drip-catching catcher is connected to the base of the ice cream cone, the edible drip-catching catcher forms the top of the ice cream cone. In such an embodiment, the two-piece arrangement described with respect to FIGS. 2A-C is converted into a single-piece configuration that includes the novel catch basin of the present disclosure.

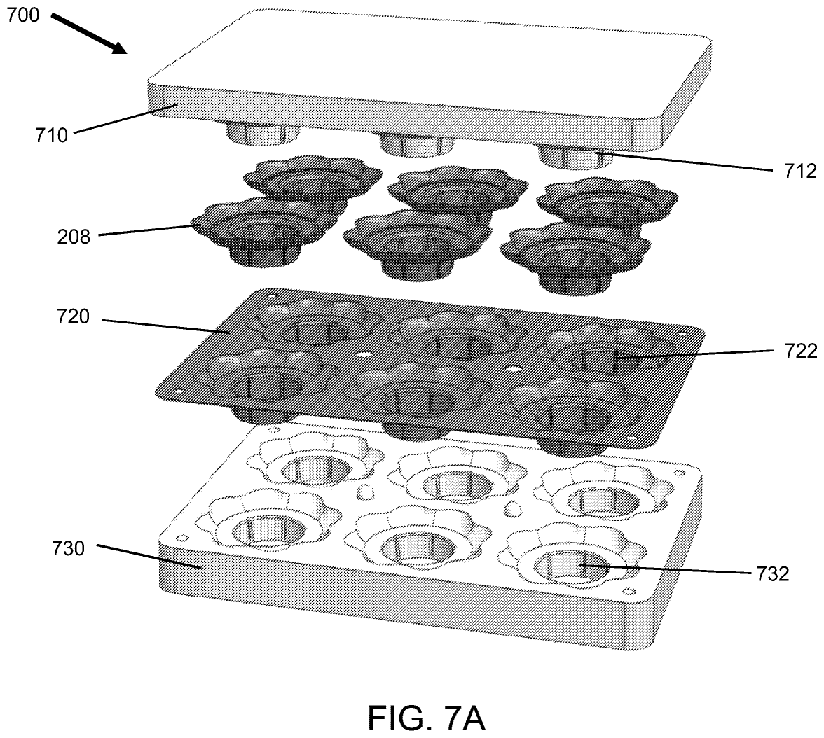

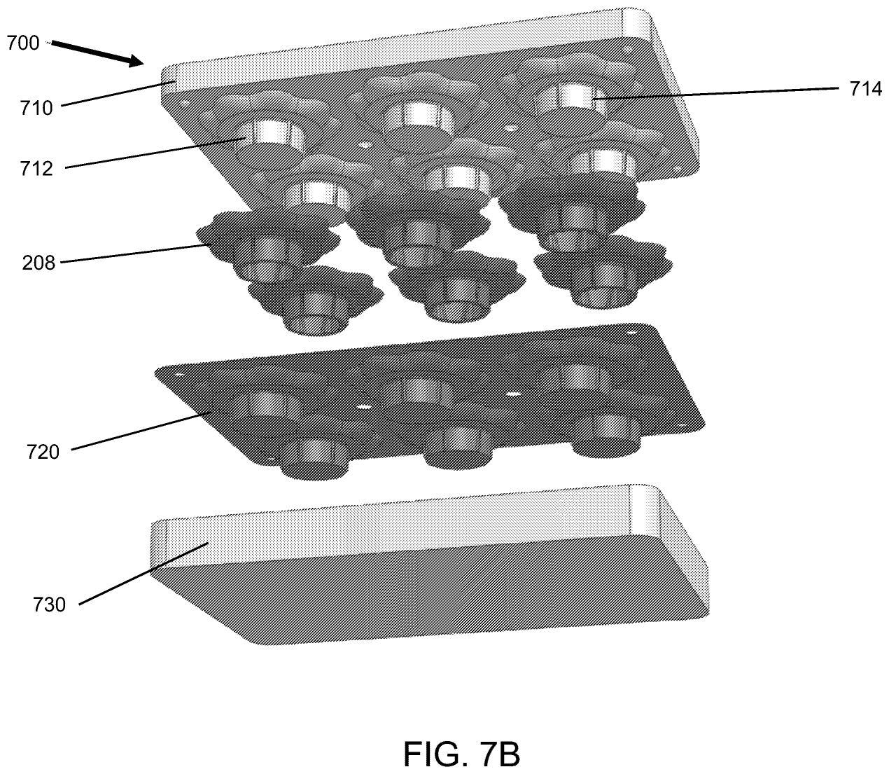

Referring now to FIGS. 7A-7B, there is illustrated a non-limiting molding arrangement for forming the edible catchers 2A-2D. The molding arrangement 700 includes a top mold 710, and insert tray 720, and a bottom mold 730. The top and bottom molds are generally formed from of metal or a durable plastic material. The insert tray is generally formed of a thinner plastic material that is typically disposable; however, this is not required. The bottom mold includes a plurality of mold cavities 730, and the top mold 710 includes a plurality of mold projections 712. Each of the mold protections includes a rib 714 that is used to form a tab 222, 224, 226 in the edible catcher. The insert tray also includes a plurality of mold cavities that are similar in shape to the mold cavities in the bottom mold. When forming the edible catchers, a confectionary or other type of edible material is poured into the mold cavities of the insert tray. Generally, the cavities of the insert tray are only partially filled with the confectionary or other type of edible material. The cavities of the insert tray can be partially filled prior to or after the insert tray in placed in the bottom mold. After the insert tray that is partially filled with confectionary or other type of edible material is positioned in the bottom mold, the top mold is lowered such that the mold protections of the top mold are at least partially inserted into the cavities of the insert tray thereby causing the confectionary or other type of edible material to be formed into the shape of the edible catchers. Generally, the confectionary or other type of edible material is allowed to partially or fully set and/or cool before the top mold is removed from the insert tray. The insert tray can thereafter be removed from the bottom mold and then wrapped and stored or the edible drip-catching catchers can be removed as needed from the insert tray.

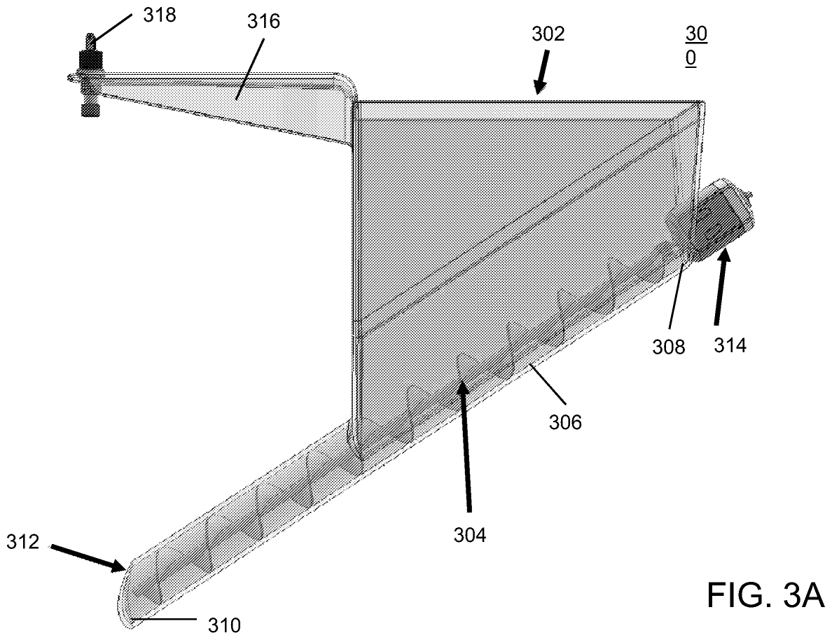

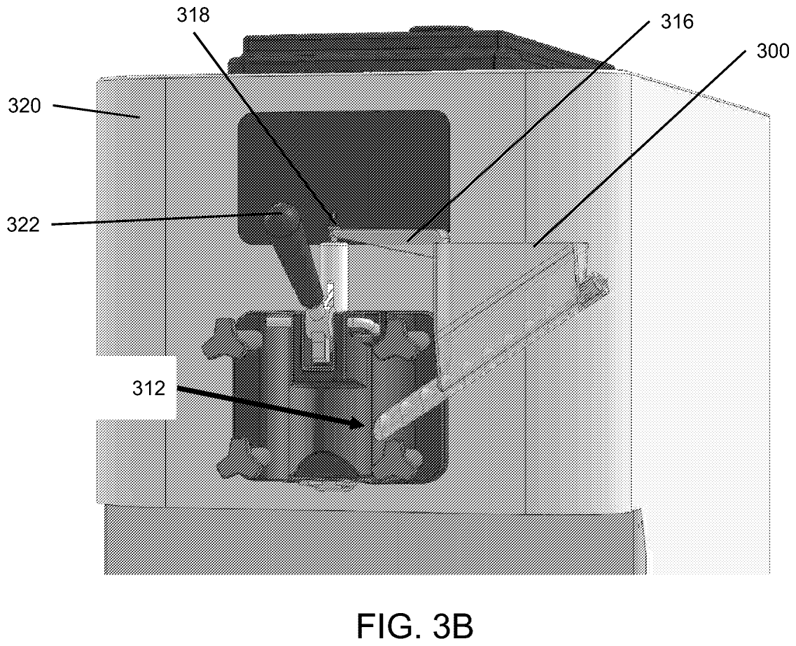

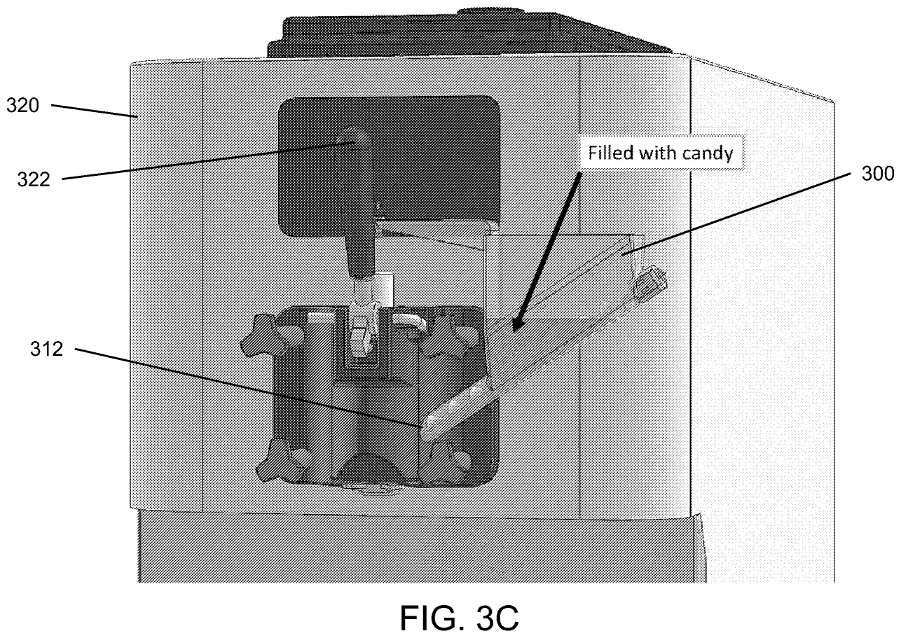

Referring now to FIGS. 3A-3C, a third exemplary non-limiting embodiment of the present disclosure is illustrated. In particular, FIGS. 3A-3C illustrate an apparatus 300 configured to dispense/mix a wide variety of toppings (e.g., fruit, nuts, chocolate, fudge, cookies, candy, confection, etc.) commonly infused with frozen confection foodstuffs. The apparatus 300 is used in conjunction with a frozen confection (e.g., ice cream, frozen yogurt, frozen custard, ice slushes, etc.) dispenser 320 (FIGS. 3B-3C) to dispense one or more toppings simultaneously with the dispensement of the frozen confection.

The main components of the apparatus 300 generally include a hopper 302 which receives the one or more toppings, an auger 304 or other type of conveying arrangement (e.g., belt, piston, etc.) which dispenses the one or more toppings, and a motor 314 which operates the auger or other type of conveying arrangement. The hopper 302 is shown as having a generally rectangular upper opening through which toppings are received; however, any desired shape may be used. The lower portion of the hopper 302 is open to provide operative contact between the auger 304 and any toppings which may be in the hopper. The auger 304 is disposed at an angle with respect to the upper opening of the hopper 302 to facilitate the dispensing of toppings; however, this is not required. While the auger 304 is illustrated as being disposed at an angle of approximately 35°, it should be understood that the auger can be disposed at any desired angle which may facilitate the dispensing of different types of toppings. In this regard, the auger 304 is illustrated as having a fixed angle with respect to the hopper 302; however, it is contemplated that modifications can be made to permit the angle of the auger to be adjustable with respect to the hopper.

A cylindrical or tubular housing 306 is disposed at the lower portion of the hopper 302 and has a first end 308 and a second end 310. The cross-sectional shape of the opening through housing 306 is non-limiting (e.g., circular, polygonal, oval, etc.). The first end 308 is generally adjacent to the rear of the hopper 302 and the motor 314. The second end 310 of the cylindrical housing 306 extends outwardly and away from the front of the hopper 302 to provide an opening 312 from which the one or more toppings are dispensed. The cylindrical housing 306 is disposed at the same angle as the auger 304, and the auger is disposed within the cylindrical housing 306. The auger 304 generally extends the length of the housing between the first and second ends 308, 310 thereof; however, this is not required. The auger 304 is operatively connected to the motor 314 at a location adjacent the first end 308 of the housing 306. At the second end 310, the auger 304 can freely rotate to permit the dispensing of the one or more toppings.

The auger 304 has a maximum diameter defined between the outermost edges of the auger's spiral blades. The cylindrical housing 306 generally has a maximum diameter that is slightly larger than the maximum diameter of the auger 304; however, this is not required. In this regard, the cylindrical housing 306 provides a clearance fit which allows the auger 304 to rotate within the housing while at the same time prevents toppings from becoming lodged between the outermost edges of the auger's spiral blades and the inner surface of the housing.

An attachment bracket 316 is optionally disposed above the second end 310 of the cylindrical housing 306 and adjacent the front of the hopper 302. The attachment bracket 316 can be configured to extend away from the front of the hopper 302 along a plane that is generally parallel with the plane along which the upper opening of the hopper is situated. A limit switch 318 for signaling the motor 314 to start or stop can optionally be included at the distal end of the attachment bracket 316. The bracket 316 (when used) is adapted to attach the dispensing/mixing apparatus 300 to a corresponding dispensing machine, such as machine 320 illustrated in FIGS. 3B and 3C.

In FIGS. 3B and 3C, the dispensing/mixing apparatus 300 is shown in attached relation to dispensing machine 320. When the apparatus 300 is attached to the machine 320, the opening 312 of the cylindrical housing 306 is disposed generally adjacent to the dispensing location of the machine 320. In this regard, a modified dispensing head (not shown) may be provided with machine 320 which is adapted to receive the opening 312 of the cylindrical housing 306 such that a frozen confection and one or more toppings are dispensed at generally the same location. As such, the one or more toppings are mixed with the frozen confection as the frozen confection is dispensed from the dispensing machine and prior to the frozen confection being inserted in an ice cream cone, a cup, or container. The attachment bracket 316 can be dimensioned such that the limit switch 318 (when used) is disposed adjacent to the dispensing mechanism 322 of machine 320; however, this is not required.

Referring specifically to FIG. 3B, the dispensing/mixing apparatus 300 and dispensing machine 320 are illustrated in a pre-dispensing configuration. In other words, apparatus 300 and machine 320 are “off”. The pre-dispensing configuration shown in FIG. 3B can be maintained via the limit switch 318, which operatively engages a component of the dispensing mechanism 322 when frozen confection is not being dispensed from machine 320. That is, the limit switch 318 is normally “open” when engaged with the dispensing mechanism 322, such that an incomplete electrical circuit prevents motor 314 from operating to rotate the auger 304.

In FIG. 3C, the dispensing/mixing apparatus 300 and dispensing machine 320 are illustrated in a dispensing configuration. In other words, apparatus 300 and machine 320 are “on”. In the dispensing configuration, the hopper 302 is filled with one or more toppings (e.g., candy, etc.) to be dispersed/infused with the frozen confection. The dispensing mechanism 322 of the machine 320 is manually activated by raising a lever, for example, and the dispensing configuration is maintained via the limit switch 318. The limit switch 318 is not operatively engaged with the dispensing mechanism 322 when frozen confection is being dispensed from machine 320. That is, the limit switch 318 is “closed” such that a complete electrical circuit allows motor 314 to operate and rotate the auger 304, thereby dispensing the toppings from the open end 312 of the cylindrical housing 306. In this regard, the exemplary dispensing/mixing apparatus 300 of the present disclosure enables dispensing of toppings simultaneously with the dispensing of ice cream. As can be appreciated, other arrangements (e.g., manual switch, etc.) can be used to activate and deactivate the auger during the dispensement of the frozen confection.

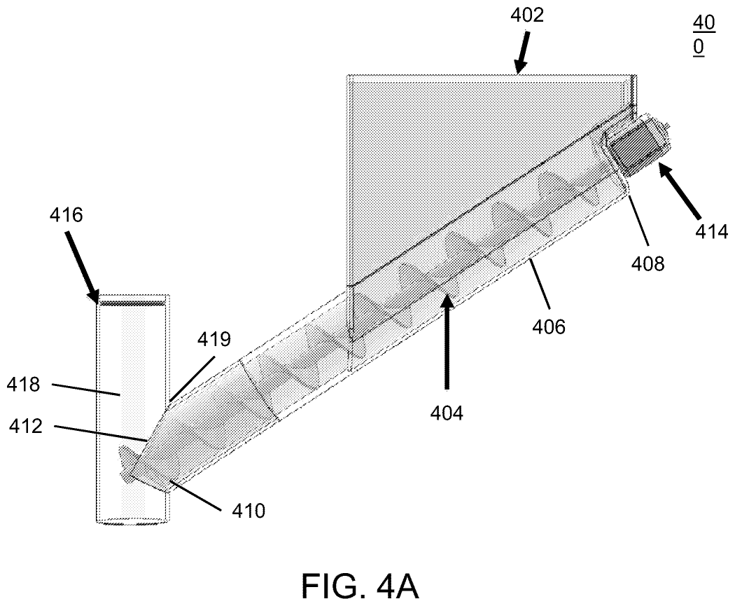

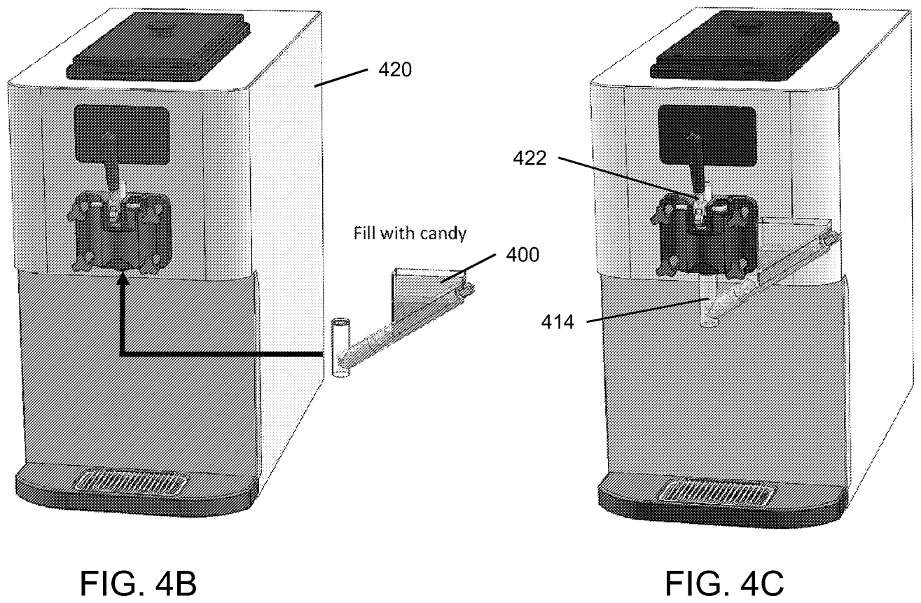

Referring now to FIGS. 4A-4C, a fourth exemplary non-limiting embodiment of the present disclosure is illustrated. In particular, FIGS. 4A-4C illustrate a second apparatus 400 configured to dispense/mix a wide variety of toppings (e.g., chocolate, candy, etc.) commonly infused with frozen confection. The apparatus 400 is used in conjunction with a frozen confection dispenser 420 (FIGS. 4B-4C) to dispense one or more toppings simultaneously with the frozen confection.

The apparatus 400 has substantially the same main components as apparatus 300, including a hopper 402 which receives the toppings, an auger 404 which dispenses the toppings, and a motor 414 which operates the auger. The auger 404 is disposed at a similar angle to that of auger 304, i.e., at an angle of approximately 35°. However, the auger 404 can generally be disposed at any desired angle to facilitate the dispensing of different types of toppings, and can optionally be adjustable with respect to the hopper 402.

A cylindrical or tubular housing 406 is disposed at the lower portion of the hopper 402 and has first and second ends 408, 410. The first end 408 is generally adjacent the rear of the hopper 402 and the motor 414. The second end 410 of the cylindrical housing 406 extends outwardly and away from the front of the hopper 402 and includes an opening 412 from which the toppings exit. The cylindrical housing 406 and auger 404 are positioned at the same angle with respect to the hopper 402, and the auger is concentrically disposed within the cylindrical housing 406. The auger 402 generally extends the length of the housing 406 between the first and second ends 408, 410 thereof and is operatively connected to the motor 414 adjacent the first end of the housing. At the second end 410, the auger 404 can freely rotate to permit the exiting of toppings.

The auger 404 has a maximum diameter defined between the outermost edges of the auger's spiral blades. The cylindrical housing 406 has a maximum diameter that is slightly larger than the maximum diameter of the auger 404; however, this is not required. In this regard, the cylindrical housing 406 provides a clearance fit which allows the auger 404 to rotate within the housing while at the same time prevents toppings from becoming lodged between the outermost edges of the auger's spiral blades and the inner surface of the housing.

In contrast to dispensing/mixing apparatus 300 discussed above, apparatus 400 does not include an attachment bracket 316. Rather, dispensing/mixing apparatus 400 has an attachment tube 416 disposed at the second end 410 of the cylindrical housing 406. The attachment tube 416 is generally vertically oriented, with the auger 404/housing 406 being disposed at an angle with respect to an upper opening of the attachment tube to facilitate the dispensing of the one or more toppings. While the auger 404 is illustrated as being disposed at an angle of approximately 35° with respect to the upper opening of the attachment tube 416, it should be understood any desired angle can be used which may facilitate the dispensing of different types of toppings.

The attachment tube 416 includes a tubular body 418 which receives the toppings that exit from the opening 412 of the cylindrical auger housing 406 and directs them downwardly for mixing with a frozen confection and dispensing into a corresponding receptacle (not shown). In this regard, the tubular body 418 includes a hole 419 adapted to receive the cylindrical auger housing 406 in fitting engagement therewith. Instead of a separate limit switch for signaling the motor, as discussed above with respect to dispensing/mixing apparatus 300, dispensing/mixing apparatus 400 uses the auger 404 as a switch to start or stop the motor. In this regard, the auger 404 extends slightly beyond the opening 412 of the cylindrical housing 406 to be approximately centrally located within the tubular body 418 of the attachment tube 416. As can be appreciated, the auger can be activated by other means (e.g., switch, etc.). Such positioning of the auger can be used to facilitate in the mixing of the toppings with the frozen confections prior to the frozen confection being dispensed into an ice cream cone or cup; however, this is not required. The attachment tube 416 is adapted to attach the dispensing/mixing apparatus 400 to a corresponding dispensing machine, such as machine 420 illustrated in FIGS. 4B and 4C.

In FIGS. 4B and 4C, the dispensing/mixing apparatus 400 is shown in attached relation to dispensing machine 420. When the apparatus 400 is attached to the machine 420, the upper opening of the attachment tube 416 is in fitting engagement with a dispensing component (e.g., a nozzle) of the machine 420. In this regard, the attachment tube 416 is adapted to provide a connection with the machine 420 such that a frozen confection and one or more toppings are dispensed at the same location.

In FIG. 4B, it is illustrated how the dispensing/mixing apparatus 400 is connected to the dispensing machine 420. In FIG. 4C, the dispensing/mixing apparatus 400 is illustrated as being connected to the dispensing machine 420. The auger 404 acts as a limit switch when frozen confection is or is not being dispensed from machine 420.

The pre-dispensing configuration is maintained via the auger 404 when frozen confection is not being dispensed via the dispensing mechanism 422 of the machine 420. In the pre-dispensing configuration, nothing is engaging the end of the auger 404 disposed within the tubular body 418 that would cause the auger to rotate. As such, when frozen confection is not being dispensed, the auger 404 maintains a switch in a normally “open” condition such that an incomplete electrical circuit prevents motor 414 from rotating the auger.

In the dispensing configuration, the hopper 402 is filled with one or more toppings (e.g., candy, etc.) to be dispersed/infused with the frozen confection. The dispensing mechanism 422 of the machine 420 is manually activated by raising a lever, for example, and the dispensing configuration is maintained via the auger 404 acting as a limit switch. That is, when the dispensing frozen confection first engages the end of the auger 404 disposed within the tubular body 418, the auger initially rotates a small amount. Upon this initial rotation, the auger 404 trips a switch to a “closed” condition such that a complete electrical circuit allows motor 414 to rotate the auger. As such, the one or more toppings exit through the opening 412 of the cylindrical housing 406 and are dispensed in a downward direction via the tubular body 418 of the attachment tube 416. In this regard, the exemplary dispensing/mixing apparatus 400 of the present disclosure enables dispensing of one or more toppings simultaneously with the dispensing of the frozen confection.

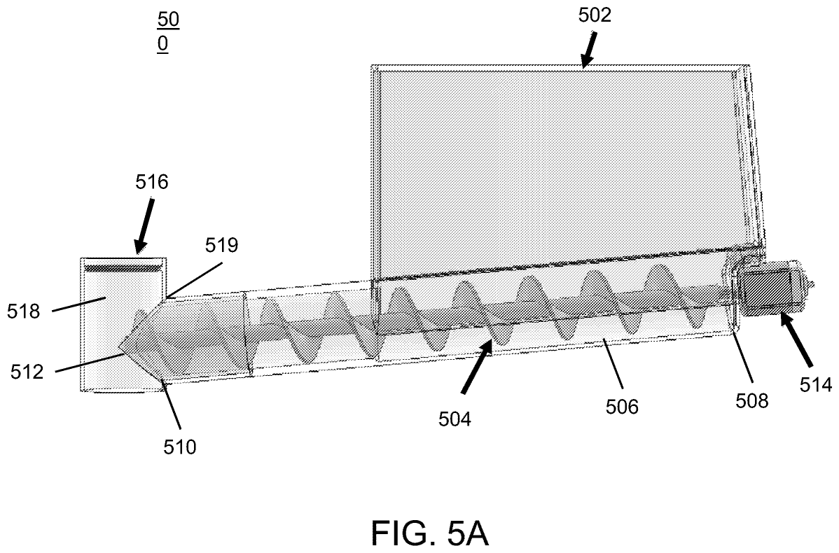

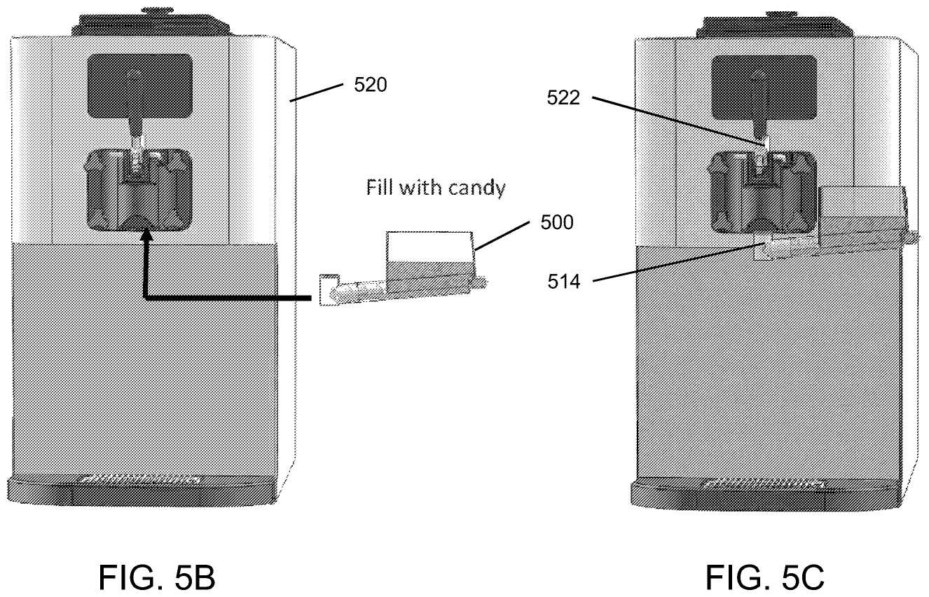

Referring now to FIGS. 5A-5C, a fifth exemplary non-limiting embodiment of the present disclosure is illustrated. In particular, FIGS. 5A-5C illustrate a third apparatus 500 configured to dispense/mix a wide variety of toppings commonly infused with a frozen confection. The apparatus 500 is used in conjunction with a frozen confection dispenser 520 (FIGS. 5B-5C) to dispense toppings simultaneously with the frozen confection.

The apparatus 500 has substantially the same main components as apparatus 400, including a hopper 502 which receives the toppings, an auger 504 which dispenses the one or more toppings, a motor 514 which operates the auger, and an attachment tube 516 for dispensing toppings in a downward direction. In contrast to apparatus 400 discussed above, auger 504 is disposed at a lower angle than that of auger 404, i.e., at an angle of approximately 5°. The smaller incline of auger 504 may be desired for the dispensing of larger toppings that need less gravitational assistance from a steep incline. Another difference from apparatus 400 described above is that the attachment tube 516 of apparatus 500 is shorter than the attachment tube 416. A shorter attachment tube 516 may also be desired for the dispensing of larger toppings, since a shorter tube means a shorter travel distance for the dispensing of larger toppings that might otherwise get stuck in a long dispensing route.

With the exception of the aforementioned differences, dispensing/mixing apparatus 500 includes the same components and operates in substantially the same manner as apparatus 400. That is, a cylindrical or tubular housing 506 is disposed at the lower portion of the hopper 502 and has first and second ends 508, 510. The first end 508 is generally adjacent the rear of the hopper 502 and the motor 514. The second end 510 of the cylindrical housing 506 extends outwardly and away from the front of the hopper 502 and includes an opening 512 from which toppings can exit. The cylindrical housing 506 and auger 504 are positioned at the same angle with respect to the hopper 502, and the auger is concentrically disposed within the cylindrical housing 506. The auger 506 generally extends the length of the housing 506 between the first and second ends 508, 510 thereof and is operatively connected to the motor 514 adjacent the first end of the housing. At the second end 510, the auger 504 can freely rotate to permit the exiting of toppings.

The auger 504 has a maximum diameter defined between the outermost edges of the auger's spiral blades, and the cylindrical housing 506 has a maximum diameter that is slightly larger than that of the auger. In this regard, the cylindrical housing 506 provides a clearance fit which allows the auger 504 to rotate within the housing while also preventing toppings from becoming lodged between the outermost edges of the auger's spiral blades and the inner surface of the housing.

The short attachment tube 516 (relative to attachment tube 416 in apparatus 400) is disposed at the second end 510 of the cylindrical housing 506. The attachment tube 516 is generally vertically oriented, with the auger 504/housing 506 being disposed at an angle with respect to an upper opening of the attachment tube to facilitate the dispensing of the one or more toppings. While the auger 504 is illustrated as being disposed at an angle of approximately 5° with respect to the upper opening of the attachment tube 516, it should be understood any desired angle can be used which may facilitate the dispensing of different types of toppings.

The attachment tube 516 includes a tubular body 518 which receives the toppings that exit from the opening 512 of the cylindrical auger housing 506. The tubular body 518 directs toppings downwardly for mixing with a frozen confection and dispensing into a corresponding receptacle (not shown). In this regard, the tubular body 518 includes a hole 519 adapted to receive the cylindrical auger housing 506 in fitting engagement therewith. Similar to apparatus 400, dispensing/mixing apparatus uses the auger 504 as a switch to start or stop the motor. In this regard, the auger 504 extends slightly beyond the opening 512 of the cylindrical housing 506 to be approximately centrally located within the tubular body 518 of the attachment tube 516. The attachment tube 516 is adapted to attach the dispensing/mixing apparatus 500 to a corresponding dispensing machine, such as machine 520 illustrated in FIGS. 5B and 5C.

In FIGS. 5B and 5C, the dispensing/mixing apparatus 500 is shown in attached relation to dispensing machine 520. When the apparatus 500 is attached to the machine 520, the upper opening of the attachment tube 516 is in fitting engagement with a dispensing component (e.g., a nozzle) of the machine 520. In this regard, the attachment tube 516 is adapted to provide a connection with the machine 520 such that a frozen confection and one or more toppings are dispensed at the same location.

FIG. 5B illustrates how the dispensing/mixing apparatus 500 is connected to the dispensing machine 520. In FIG. 5C, the dispensing/mixing apparatus 500 and dispensing machine 520 are illustrated in the “dispensing” configuration discussed above with respect to apparatus 400.

Accordingly, the exemplary dispensing/mixing apparatus 500 of the present disclosure enables dispensing of large toppings (relative to the toppings dispensed in apparatuses 300 and 400 discussed above) simultaneously with the dispensing of the frozen confection.

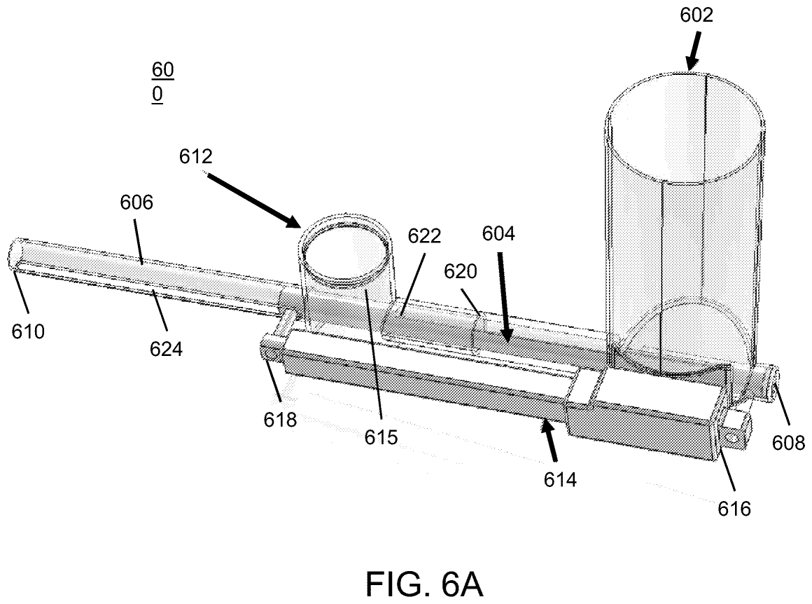

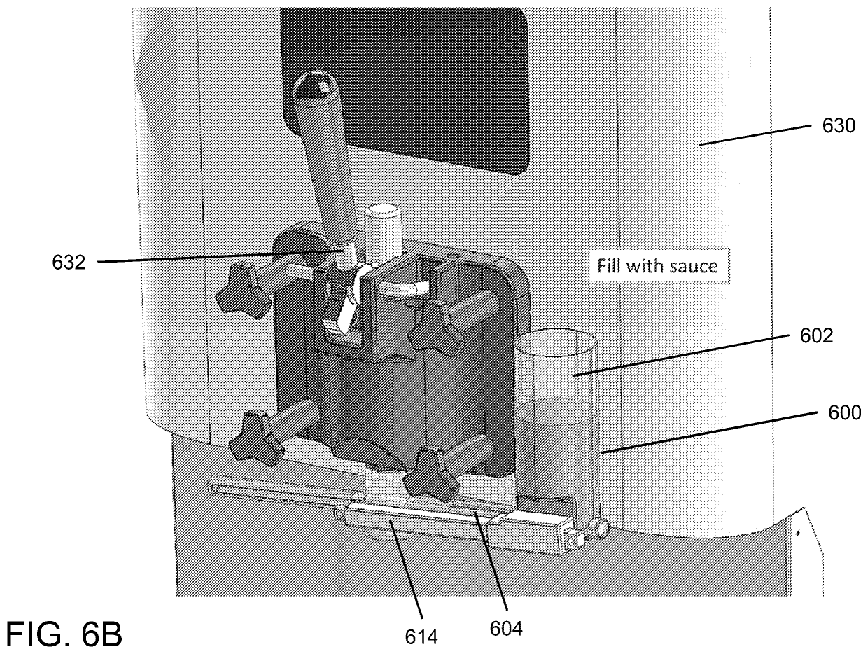

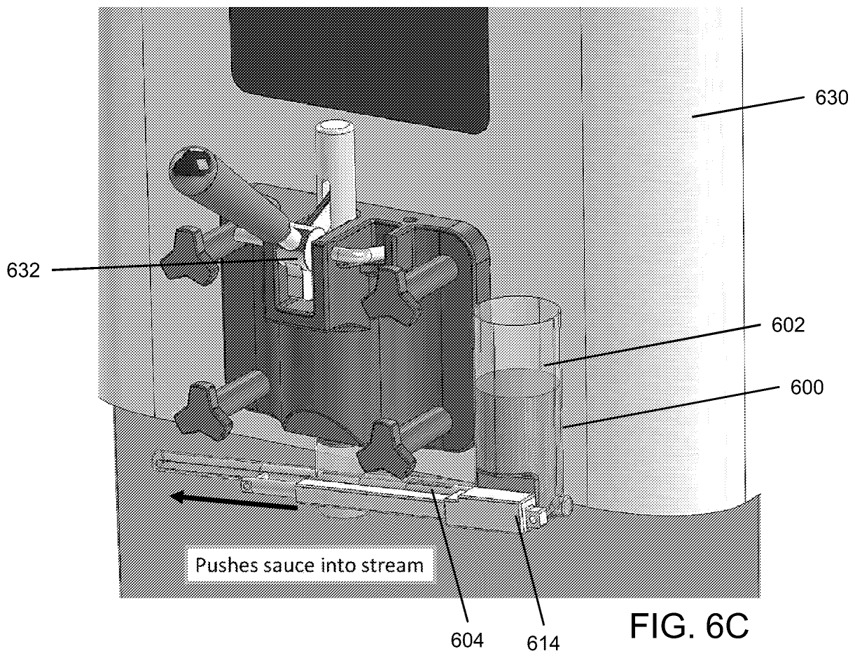

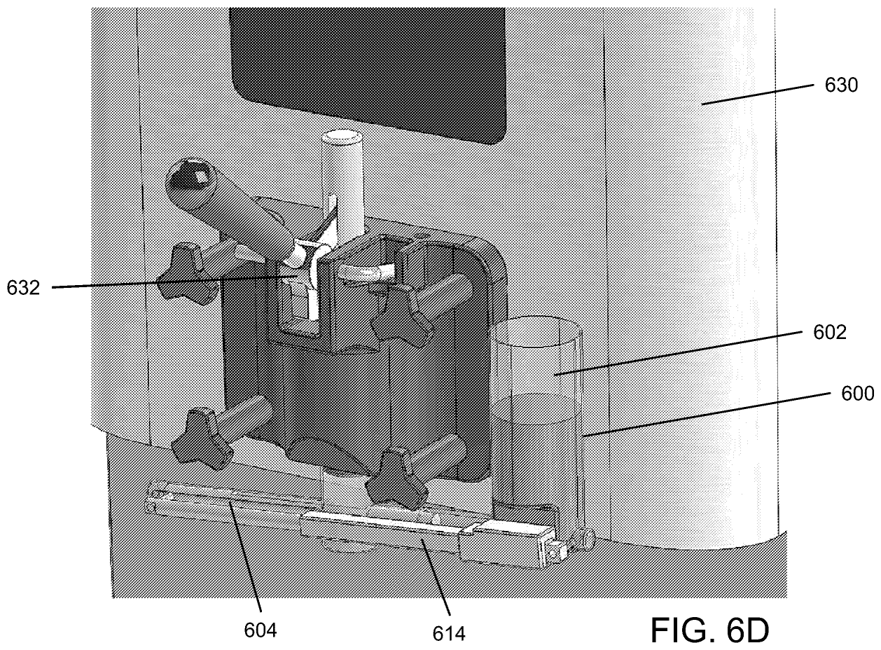

Referring now to FIGS. 6A-6D, a sixth exemplary non-limiting embodiment of the present disclosure is illustrated. In particular, FIGS. 6A-6D illustrate a third apparatus 600 configured to dispense/mix a wide variety of toppings commonly infused with a frozen confection. The apparatus 600 is used in conjunction with a frozen confection dispensing machine 630 (FIGS. 6B-4D) to dispense one or more toppings simultaneously with the frozen confection. Apparatus 600, in contrast to apparatuses 300, 400, and 500 discussed above, is specifically adapted to dispense liquid toppings (e.g., sauces, syrups, etc.) simultaneously with the frozen confection.

The main components of the apparatus 600 generally include a hopper 602 which receives the liquid topping, a plunger 604 which dispenses the liquid topping, and a linear actuator 614 which operates the plunger. The hopper 602 is shown as having a generally cylindrical/tubular shape with a circular upper opening through which liquid toppings are received; however, any desired shape may be used. The lower portion of the hopper 602 is open to provide operative contact between the plunger 604 and the liquid topping in the hopper. The plunger 604 is disposed at an angle with respect to the upper opening of the hopper 602 to facilitate the dispensing of liquid toppings; however, this is not required. While the plunger 604 is illustrated as being disposed at an angle of approximately 5°, it should be understood that the plunger can be disposed at any desired angle which may facilitate the dispensing of different types of liquid toppings. In this regard, the plunger 604 is illustrated as having a fixed angle with respect to the hopper 602; however, it is contemplated modifications can be made to permit the angle of the plunger to be adjustable with respect to the hopper.

A cylindrical or tubular housing 606 is disposed at the lower portion of the hopper 602 and has a first end 608 and a second end 610. The first end 608 is generally adjacent to the rear of the hopper 602 and the stationary end 616 of the actuator 614. The second end 610 of the cylindrical housing 606 extends outwardly and away from the front of the hopper 602 and provides a guide track 624 for the moving end 618 of actuator 614 to follow. The cylindrical housing 606 is disposed at the same angle as the plunger 604, and the plunger is concentrically disposed within the cylindrical housing. The plunger 604 can generally travel the length of the housing between the first and second ends 608, 610 thereof. The plunger 604 is operatively connected to the actuator 618 at the moving end 618, and the stationary end 616 of the actuator is attached adjacent the first end 608 of the hopper.

The plunger 604 has a maximum diameter defined between the outermost surface of the plunger's cylindrical body. The cylindrical housing 606 has a maximum diameter that is substantially similar to the maximum diameter of the plunger 604. In this regard, the plunger 604 sealingly engages the inner sidewall of the cylindrical housing 606 such that liquid toppings are substantially expelled from the housing by the plunger.

The dispensing/mixing apparatus 600 has an attachment tube 612 disposed at an approximately central location between first and second ends 608, 610 of the cylindrical housing 606. The attachment tube 612 is generally vertically oriented, with the plunger 604/housing 606 being disposed at an angle with respect to an upper opening of the attachment tube to facilitate the dispensing of toppings. While the plunger 604 is illustrated as being disposed at an angle of approximately 5° with respect to the upper opening of the attachment tube 612, it should be understood any desired angle can be used which may facilitate the dispensing of different types of liquid toppings.

The attachment tube 612 includes a tubular body 615 which receives the liquid topping that is pushed by plunger 604. In particular, the tubular body 615 includes a T-pipe 620 oriented perpendicular to the vertically arranged attachment tube 612 and extends in a direction toward the hopper 602. The tubular body 615 and T-pipe 620 are fluidically connected to one another. The T-pipe 620 provides for a sliding engagement between an inner surface thereof and a portion of the plunger 604 having a channel 622. The liquid topping that is stored in the hopper 602 collects in the channel 622 of the plunger 604. When the actuator 614 pushes the plunger 604 through the housing 606 and T-pipe 620, the channel portion of the plunger eventually reaches the attachment tube 612. At that time, the liquid topping is able to flow out of the channel 622 and into the attachment tube 612, where the liquid topping is directed downwardly for mixing with the frozen confection and dispensing into a corresponding receptacle (not shown).

In FIGS. 6B-6D, the dispensing/mixing apparatus 600 is shown in attached relation to dispensing machine 630. When the apparatus 600 is attached to the machine 630, the upper opening of the attachment tube 612 is in fitting engagement with a dispensing component (e.g., a nozzle) of the machine 630. In this regard, the attachment tube 612 is adapted to provide a connection with the machine 630 such that ice cream and liquid toppings are dispensed at the same location.

Referring specifically to FIG. 6B, the dispensing/mixing apparatus 600 and dispensing machine 630 are illustrated in a pre-dispensing configuration. In other words, apparatus 600 and machine 630 are “off”. The pre-dispensing configuration shown in FIG. 6B can be maintained via a switch (not shown), which operatively engages a component of the dispensing mechanism 632 when ice cream is not being dispensed from machine 630. That is, the limit switch is normally “open” when engaged with the dispensing mechanism 632, such that an incomplete electrical circuit prevents actuator 614 from advancing the plunger 604 and dispensing liquid toppings. In the pre-dispensing configuration of FIG. 6B, the hopper 602 is filled with liquid toppings such as syrups or sauces to be dispersed/infused with the frozen confection.

Referring now to FIG. 6C, the dispensing/mixing apparatus 600 and dispensing machine 630 are illustrated in a dispensing configuration. In other words, apparatus 600 and machine 630 are “on”. The dispensing mechanism 632 of the machine 630 is manually activated by raising a lever, for example, to dispense ice cream. The dispensing configuration of FIG. 6C for apparatus 600 is maintained via the limit switch, which is “closed” during ice cream dispensing. When the switch is closed, a complete electrical circuit is formed which allows actuator 614 to move the plunger 604. The actuator 604 pushes the topping-filled channel portion 622 through the T-pipe 620 and to the attachment tube 612. As the plunger advances, liquid topping flows out of the channel portion 622 as it comes into contact with the stream of dispensing frozen confection in the attachment tube and mixes therewith. In this regard, the exemplary dispensing/mixing apparatus 600 of the present disclosure enables dispensing of liquid topping simultaneously with the dispensing of a frozen confection.

Referring now to FIG. 6D, the dispensing/mixing apparatus 600 and dispensing machine 630 are illustrated in a fully dispensed configuration. That is, the dispensing mechanism 632 of the machine 630 has released a quantity of frozen confection sufficient to adequately disperse a desired amount of liquid topping within the frozen confection. The actuator 604 has extended fully and has thereby advanced the entire topping-filled channel portion 622 of the plunger 604 through the T-Pipe 620 and attachment tube 612. The actuator 604 will then retract, pulling the plunger 604 backward and under the hopper 602 where more liquid topping can fill the channel 622.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

1-23 (canceled)

24. An ice cream cone arrangement comprising a single ice cream cone and a confectionary catcher that is configured to inhibit or prevent melted frozen confection from running down an outside of said ice cream cone; said ice cream cone includes a top surface defining an upper lip, an outer side surface, and an inner surface defining a cavity; said confectionary catcher includes an upper body portion and a lower body portion; said upper and lower body portions formed of an edible confectionary that can be consumed with said ice cream cone; said upper body portion having a rim, a catch basin having a top surface and a bottom surface, and a central opening; said lower body portion sized and shaped to be fully inserted into said cavity of said ice cream cone when said confectionary catcher is used with said ice cream cone; said ice cream cone and said confectionary catcher configured to receive the frozen confection when said lower body portion is fully inserted into said cavity of said ice cream cone; said catch basin includes a ledge portion wherein an entirety of said ledge portion is flat and lies in a plane that is perpendicular to a longitudinal axis of said lower body portion; a bottom surface of said ledge portion of said catch basin is configured to contact and rest on said top surface of said ice cream cone such that said catch basin is configured to overlie said upper lip of said ice cream cone when said lower body portion of said confectionary catcher is inserted into said cavity of said ice cream cone; said catch basin is positioned between said central opening and said rim; said catch basin extends outwardly from said central opening; at least a portion of said rim extends upwardly from said catch basin; a top edge of said rim has an outer perimeter that is greater than an outer perimeter of said upper lip of said ice cream cone when said lower body portion of said confectionary catcher is inserted into said cavity of said ice cream cone; said upper and lower body portions connected together; a maximum cross section area of said upper body portion is greater than a maximum cross section area of said lower body portion; neither of said upper body portion nor said lower body portion is configured to contact and partially or fully encircle any portion of said outer side surface of said ice cream cone when said lower body portion of said confectionary catcher is inserted into said cavity of said ice cream cone.

25. The ice cream cone and device as defined in claim 24, wherein said rim of said upper body portion angles outwardly and upwardly relative to said lower body portion.

26. The ice cream cone and device as defined in claim 24, wherein said rim includes a plurality of catch regions having a curvilinear profile.

27. The ice cream cone and device as defined in claim 24, wherein the entirety of the catch basin comprises the ledge portion.

28. A confectionary device for limiting melted frozen confection from running down an outside of an ice cream cone that has a top surface defining an upper lip, an outer side surface, and an inner surface defining a cavity; said confectionary catcher includes an upper body portion and a lower body portion; said upper and lower body portions formed of an edible confectionary that can be consumed with the ice cream cone; said upper body portion having a rim, a catch basin having a top surface and a bottom surface, and a central opening; said lower body portion sized and shaped to be fully inserted into the cavity of the ice cream cone when said confectionary catcher is used with the ice cream cone; said confectionary catcher configured to receive the frozen confection when said lower body portion is fully inserted into the cavity of the ice cream cone; said catch basin includes a ledge portion wherein an entirety of said ledge portion is flat and lies in a plane that is perpendicular to a longitudinal axis of said lower body portion; a bottom surface of said ledge portion of said catch basin is configured to contact and rest on the top surface of the ice cream cone such that said catch basin is configured to overlie the upper lip of the ice cream cone when the lower body portion of said confectionary catcher is inserted into the cavity of the ice cream cone; said catch basin is positioned between said central opening and said rim; said catch basin extends outwardly from said central opening; at least a portion of said rim extends upwardly from said catch basin; a top edge of said rim has an outer perimeter that is greater than an outer perimeter of the upper lip of the ice cream cone when said lower body portion of said confectionary catcher is inserted into the cavity of the ice cream cone; said upper and lower body portions connected together; a maximum cross section area of said upper body portion is greater than a maximum cross section area of said lower body portion; neither of said upper body portion nor said lower body portion is configured to contact and partially or fully encircle any portion of the outer side surface of the ice cream cone when said lower body portion of said confectionary catcher is inserted into the cavity of the ice cream cone.

29. The confectionary device as defined in claim 28, wherein said lower body portion includes a plurality of securing tabs that are spaced from one another; said plurality of securing tabs are located in the cavity of the ice cream cone when said lower body portion of said confectionary catcher is inserted into the cavity of the ice cream cone; a longitudinal length of said securing tabs is at least 25% of a longitudinal length of said lower body portion.

30. The confectionary device as defined in claim 28, wherein said rim includes a plurality of catch regions; said upper body portion includes a plate portion positioned between two of the plurality of catch regions; said plate portion being positioned within the rim and transverse thereto.

31. The confectionary device as defined in claim 29, wherein said rim includes a plurality of catch regions; said upper body portion includes a plate portion positioned between two of the plurality of catch regions; said plate portion being positioned within the rim and transverse thereto.

32. The confectionary device as defined in claim 29, wherein a longitudinal length of a gap located between two of said securing tabs is less than a longitudinal length of said lower body portion.

33. The confectionary device as defined in claim 31, wherein a longitudinal length of a gap located between two of said securing tabs is less than a longitudinal length of said lower body portion.

34. The confectionary device as defined in claim 28, wherein said catch basin extends outwardly from said central opening and said rim extends upwardly from an outer peripheral edge of said catch basin.

35. The confectionary device as defined in claim 33, wherein said catch basin extends outwardly from said central opening and said rim extends upwardly from an outer peripheral edge of said catch basin.

36. The confectionary device as defined in claim 30, wherein said plurality of catch regions have a curvilinear profile.

37. The confectionary device as defined in claim 35, wherein said plurality of catch regions have a curvilinear profile.

38. A method for limiting melted frozen confection from running down an outside of cone comprising:
providing a single ice cream cone; said ice cream cone includes a top surface defining an upper lip, an outer side surface, and an inner surface defining a cavity; said ice cream cone formed of an edible material;
providing a confectionary catcher; said confectionary catcher includes an upper body portion and a lower body portion; said upper and lower body portions formed of an edible confectionary that can be consumed with said ice cream cone; said upper body portion has a rim, a catch basin having a top surface and a bottom surface, and a central opening; said lower body portion is sized and shaped to be inserted into said cavity of said ice cream cone when said confectionary catcher is used with said ice cream cone; said confectionary catcher is configured to receive frozen confection when said lower body portion is inserted into said cavity of said ice cream cone; said catch basin includes a ledge portion wherein said ledge portion is flat and lies in a plane that is perpendicular to a longitudinal axis of said lower body portion; said catch basin is positioned between said central opening and said rim; said catch basin extends outwardly from said central opening; at least a portion of said rim extends upwardly from said catch basin; said upper and lower body portions connected together; a maximum cross section area of said upper body portion is greater than a maximum cross section area of said lower body portion;
inserting said lower body portion of said confectionary catcher is inserted into the cavity of the ice cream cone; a bottom surface of said ledge portion of said catch basin is configured to contact and rest on the top surface of said ice cream cone such that said catch basin overlies said upper lip of said ice cream cone when said lower body portion of said confectionary catcher is inserted into said cavity of said ice cream cone; a top edge of said rim has an outer perimeter that is greater than an outer perimeter of the upper lip of the ice cream cone when said lower body portion of said confectionary catcher is inserted into the cavity of the ice cream cone; neither of said upper body portion nor said lower body portion contact or partially encircle any portion of said outer side surface of said ice cream cone when said lower body portion of said confectionary catcher is inserted into said cavity of said ice cream cone.
